(19) United States
(12) Patent Application Publication
(10) Pub. No.: US 2014/0379553 A1
(43) Pub. Date: Dec. 25, 2014

(54) METHOD AND A SYSTEM FOR SENDING AN ELECTRONIC MESSAGE

(71) Applicant: Zomojo Pty Ltd, Sydney (AU)

(72) Inventors: Matthew John Hurd, Belrose (AU); David Charles Ambler Snowdon, Darlinghurst (AU)

(21) Appl. No.: 14/484,180

(22) Filed: Sep. 11, 2014

Related U.S. Application Data
(63) Continuation of application No. PCT/AU2012/000485, filed on May 4, 2012.

(30) Foreign Application Priority Data
Mar. 12, 2012 (AU) 2012900980

(51) Int. Cl. H04L 29/08; H04L 12/58

(52) U.S. Cl. CPC H04L 29/08558; G06Q 40/04; H04L 51/08
USPC 705/37; 709/206

(57) ABSTRACT

Disclosed is a system for reducing latency. A message sender can send to an electronic message receiver an electronic message portion comprising at least one of a plurality of data packages for transmission that an electronic message has been divided between. The plurality of data packages has more data packages than expected by the electronic message receiver. An electronic trigger information receiver can receive electronic trigger information. The message sender can send to the electrical message receiver the remaining of the plurality of data packages in response to receipt of the electronic trigger information. A data formatter can format each of the plurality of data packages to cause the electronic message receiver to hold the at least one of the plurality of data packages when received in anticipation of receiving the remaining of the plurality of data packages and subsequently combine the plurality of data packages once received.

### CROSS-REFERENCE TO RELATED APPLICATIONS

This application is a continuation application of PCT application PCT/AU2012/000485 entitled “A Method and a System for Sending an Electronic Message,” filed on May 4, 2012, which claims priority to Australian Patent Application No. 2012900980, filed on Mar. 12, 2012, which are herein incorporated by reference in their entirety for all purposes.

### TECHNICAL FIELD

The disclosure herein generally relates to a method and a system for sending an electronic message, and particularly but not exclusively to reducing the latency of an electronic message, an example of which includes, but is not limited to, a financial instrument order sent to a stock exchange.

### BACKGROUND

The latency of an electronic message sent over an electronic network may be, in some circumstances, an important factor in securing a favourable outcome. For example, being the first to have a complete electronic trade order received by a stock exchange may establish trade priority. Favourable prices for financial instruments such as shares, derivatives and futures may then be taken advantage of. In another example, a favourable outcome for an individual playing a networked electronic game may be determinant on the latency of a gaming command received by a gaming system. Being able to send a low latency message to place a wager or a bid at an auction, for example, may increase the probability of securing good odds, a good price, or a successful purchase.

### SUMMARY

Disclosed herein is a method for reducing latency. The method comprises the step of dividing an electronic message between a plurality of data packages for transmission. The plurality of data packages have more data packages than expected by an electronic message receiver. The method comprises the step of sending to the electronic message receiver an electronic message portion comprising at least one of the plurality of data packages. The method comprises the step of receiving electronic trigger information indicating that the remaining of the plurality of data packages are to be sent to the electronic message receiver. The method comprises the step of sending to the electronic message receiver the remaining of the plurality of data packages. Each of the plurality of data packages are formatted to cause the electronic message receiver to hold the at least one of the plurality of data packages when received in anticipation of receiving the remaining of the plurality of data packages and subsequently combine the plurality of data packages once received.

The time period for sending the remaining of the plurality of data packages is less than the time period for sending the plurality of data packages. Consequently, the latency of sending the electronic message is effectively less than if all of the plurality of data packages were sent after receiving the electronic trigger information.

In an embodiment, the electronic message receiver is an electronic order receiver that may, but may not necessarily, be located at an exchange. The electronic message may comprise electronic order information comprising at least one of a financial instrument trade order, a domain name order, an electronic commercial transaction order, or generally any order. For example, the electronic message portion may comprise at least one of protocol header information, electronic message receiver defined header information, and information defined at the origin of the electronic message. Header information, for example, generally contains information common to every electronic message. A stockbroker, for example, may include standard information in financial instrument orders sent to an exchange, for example broker identification, operator identification, date information, customer account information, or generally any suitable information. The effective latency may be reduced by sending the standard, or predetermined, data (in the form of the electronic message portion) before the variable data (in the form of the remaining of the plurality of data packages).

Servers such as stock exchange and gaming servers may expect to receive the electronic message divided between a particular number of data packages, for example one Transmission Control Protocol (TCP) segment carried by a one Internet Protocol (IP) packet. Consequently, it is surprising that a latency advantage may be obtained by purposely not following the expectations of a server. An achieved latency advantage is even more surprising given that sending more packets than expected incurs overheads including, for example, extra processing steps, resources, processing time, and an overall increase in total transmission time. Furthermore, some stock exchange protocols may not be compatible with the above-disclosed method without further effort by the message sender. It may, for example, be necessary to keep a transmission session, the parameters of which are generally but not necessarily defined by the server, alive by at least one of sending periodic ‘heartbeats’, periodically sending corrupted or erroneous packets, sending multiple order cancellations, and sending orders that will not be accepted because they are outside of the market best price range. These actions may incur further overheads, and yet contribute to a latency advantage.

In another embodiment, the electronic message comprises at least one of electronic gaming information indicative of a gaming command, and electronic wager information indicative of a wager.

Generally, but not necessarily, there is a temporal period between the sending of the electronic message portion and the sending of the remaining of the plurality of data packages. The period may be greater than 1000 ns. The period may be greater than 10 μs. The period may be greater than 100 μs. The period may be greater than 1 ms. The period may be greater than 1 second. The period may be greater than 60 seconds. The period may be greater than 1 hour. The temporal period may be less than any one of 1 hour, 60 second, 1 second, 1 ms, 100 μs, 10 μs and 1000 ns. Generally, the temporal period is dependent on circumstance, and the time of the sending of the electronic message portion and the remaining of the plurality of data packages may be uncorrelated.

An embodiment of the method comprises the step of determining the quantity of data packages that the electronic message receiver expects the message to be divided between. The method may comprise the step of electronically querying the server for the expected quantity of data packages. Alternatively, the method may comprise the step of consulting documentation setting out the expected quantity of data packages.

In an embodiment, at least some information within the remaining of the plurality of data packages is created after the step of sending the electronic message portion to the electronic message receiver. There may be no reason to wait for, for example, for a stockbroker to initiate an order. This may result in a reduction in latency.

In an embodiment, the at least one of the plurality of data packages comprises a Transmission Control Protocol segment.

In an embodiment, the remaining of the plurality of data packages comprises another TCP segment. The other TCP segment may have a lesser sequence number than the TCP segment. That is, the TCP segments may be sent out of the conventional order. The remaining of the plurality of data packages may comprise a plurality of other TCP segments.

The TCP protocol guarantees packet delivery, and assembly of packets in the correct order if they are received out of order. Consequently, the use of the TCP protocol may be suitable. Many, but not necessarily all, exchange servers use the TCP protocol.

In an embodiment, the electronic message portion comprises at least a first IP fragment.

In an embodiment, the remaining of the plurality of data packages comprises at least a second IP fragment.

IP fragmentation is generally not made available to applications and/or users by a standard operating system. IP fragmentation may require extra processing. Consequently it is surprising that a latency advantage may be achieved using IP fragmentation.

In an embodiment, the step of receiving electronic trigger information comprises the step of receiving remaining message information from which the remaining of the plurality of data packages are generated. The remaining message information may be the electronic trigger information.

Disclosed herein is a system for reducing latency. The system comprises a message sender arranged to send to an electronic message receiver an electronic message portion comprising at least one of a plurality of data packages for transmission that an electronic message has been divided between. The plurality of data packages has more data packages than expected by the electronic message receiver. The system comprises an electronic trigger information receiver arranged to receive electronic trigger information indicating that the remaining of the plurality of data packages are to be sent to the electronic message receiver. The message sender is arranged to send to the electrical message receiver the remaining of the plurality of data packages. The system comprises a data formatter arranged to format each of the plurality of data packages to cause the electronic message receiver to hold the at least one of the plurality of data packages when received in anticipation of receiving the remaining of the plurality of data packages and subsequently combine the plurality of data packages once received.

An embodiment of the system comprises data storage arranged to store the at least one of the plurality of data packages.

An embodiment of the system comprises an electronic message receiver expectation determiner arranged to determine the quantity of data packages that the electronic message receiver expects the message to be divided between.

In an embodiment, the message sender is arranged to establish a TCP session with the electronic message receiver.

In an embodiment, the message sender is arranged to include a TCP segment in the electronic message portion and to include another TCP segment in the remaining of the plurality of data packages. The other TCP segment may have a lesser sequence number than the TCP segment.

In an embodiment, the message sender is arranged to include in the electronic message portion at least a first IP fragment.

In an embodiment, the message sender is arranged to include in the remaining of the plurality of data packages at least a second IP fragment.

In an embodiment, the electronic trigger receiver is arranged to receive remaining message information from which the remaining of the plurality of data packages are generated.

In an embodiment, the electronic message comprises at least one of electronic order information indicative of an order, electronic gaming information indicative of a gaming command, and electronic wager information indicative of a wager.

In an embodiment, the electronic message receiver is an electronic order receiver, the electronic message comprises electronic order information comprising at least one of a financial instrument trade order, a domain name order, and an electronic commercial transaction order.

Disclosed herein is a method for reducing latency. The method comprises the step of sending to an electronic message receiver a plurality of alternative message portions. Each of the alternative message portions is an alternative portion of an electronic message. The method comprises the step of receiving electronic trigger information indicating that a selected one of the plurality of alternative message portions is to be completed. The method comprises the step of sending to the electronic message receiver a remaining message portion that complements the selected one of the plurality of alternative message portions.

For example, a stockbroker may send a plurality of alternative message portions, each of the plurality of message portions being an incomplete order that differs from the other of the plurality of alternative message portions. The stockbroker may use market information, for example, to select which one of the plurality of orders to complete based of market conditions. The stockbroker is, consequently, able to take advantage of several possible eventualities in relation to stock price, traded stock volumes, client instructions etc.

Generally, but not necessarily, there is a temporal period between the sending of the plurality of alternative message portions and the sending of the remaining message portion.

In an embodiment, the plurality of alternative message portions each comprise at least one of protocol header information, electronic message receiver defined header information, and information defined at the origin of the electronic message, examples of which include but are not limited to stock identifier, stock price, order type information (eg. Buy or sell).

In an embodiment, at least some information within the remaining message portion is created after the step of sending the plurality of alternative message portions.

In an embodiment, the plurality of alternative message portions each comprise a respective IP fragment. The remaining message portion may comprise another IP fragment.

In an embodiment, the step of receiving electronic trigger information comprises the step of receiving remaining message information from which the remaining message portion is generated.

In an embodiment, the electronic message comprises at least one of electronic order information indicative of an order, electronic gaming information indicative of a gaming command, and electronic wager information indicative of a wager.

In an embodiment, the electronic message receiver is an electronic order receiver, the electronic message comprises electronic order information comprising at least one of a financial instrument trade order, a domain name order, and an electronic commercial transaction order.

Disclosed herein is a system for reducing latency. The system comprises a message sender arranged to send to an electronic message receiver a plurality of alternative message portions. Each of the alternative message portions is an alternative portion of an electronic message. The system comprises an electronic trigger information receiver arranged to receive electronic trigger information indicating that a selected one of the plurality of alternative message portions is to be completed. The message sender is arranged to send to the electronic message receiver a remaining message portion that complements the selected one of the plurality of alternative message portions.

An embodiment of the system comprises data storage arranged to store the plurality of alternative message portions.

In an embodiment, the plurality of alternative message portions each comprise at least one of protocol header information, electronic message receiver defined header information, and information defined at the origin of the electronic message.

In an embodiment, the plurality of alternative message portions each comprise a respective IP fragment and the remaining message portion comprises another IP fragment.

In an embodiment, the electronic trigger information receiver is arranged to receive the remaining message information from which the remaining message portion is generated.

In an embodiment, the electronic message comprises at least one of electronic order information indicative of an order, electronic gaming information indicative of a gaming command, and electronic wager information indicative of a wager.

In an embodiment, the electronic message receiver is an electronic order receiver, the electronic message comprises electronic order information comprising at least one of a financial instrument trade order, a domain name order, and an electronic commercial transaction order.

Disclosed herein is a method for reducing latency. The method comprises the step of sending to an electronic message receiver, preliminary message data indicative of an incomplete portion of the electronic message. The method comprises the step of receiving electronic trigger information indicating that remaining message data indicative of the remainder of the electronic message is to be sent. The method comprises the step of sending to the electronic message receiver the remaining message data in response to receipt of the electronic trigger information. The sent preliminary message data and the sent remaining message data are formatted to cause the electronic message receiver to hold the preliminary message data until receipt of the remaining message data and subsequently combine the preliminary message data and the remaining message data.

Disclosed herein is a system for reducing latency. The system comprises a message sender arranged to send to an electronic message receiver preliminary message data indicative of an incomplete portion of the electronic message. The system comprises an electronic trigger information receiver arranged to receive electronic trigger information. The system comprises the step of the message sender being further arranged to send to the electronic message receiver remaining message data in response to receipt of the electronic trigger information. The remaining message data is indicative of the remainder of the electronic message. The system comprises a data formatter arranged to format the preliminary message data and the remaining message data to cause the electronic message receiver to hold the preliminary message data until receipt of the remaining message data and subsequently combine the preliminary message data and the remaining message data.

Any of the above steps of any of the above described methods may be performed in a processor.

Any one or more features of the methods, systems, processor readable tangible media, and programs described above may be combined.

### BRIEF DESCRIPTION OF THE DRAWINGS

Embodiments of a method for sending a message and a system for sending a message will now be described by way of example only with reference to the accompanying figures in which:

FIG. 1 shows a flow diagram of an embodiment of a method for reducing latency;

FIG. 2 shows a schematic diagram of an embodiment of a system for reducing latency that can perform the steps of the method of FIG. 1 and/or FIG. 3;

FIG. 3 shows a flow diagram of another embodiment of a method for reducing latency;

FIG. 4 shows a schematic diagram of the architecture of system of FIG. 2;

FIG. 5 shows another embodiment of system for reducing latency that can perform the steps of the method of FIG. 1 and/or FIG. 3;

FIG. 6 shows yet another embodiment of a system for reducing latency that can perform the steps of the method of FIG. 1 and/or FIG. 3; and

FIG. 7 shows a graphical representation of a message latency calculation.

### DESCRIPTION OF EMBODIMENTS

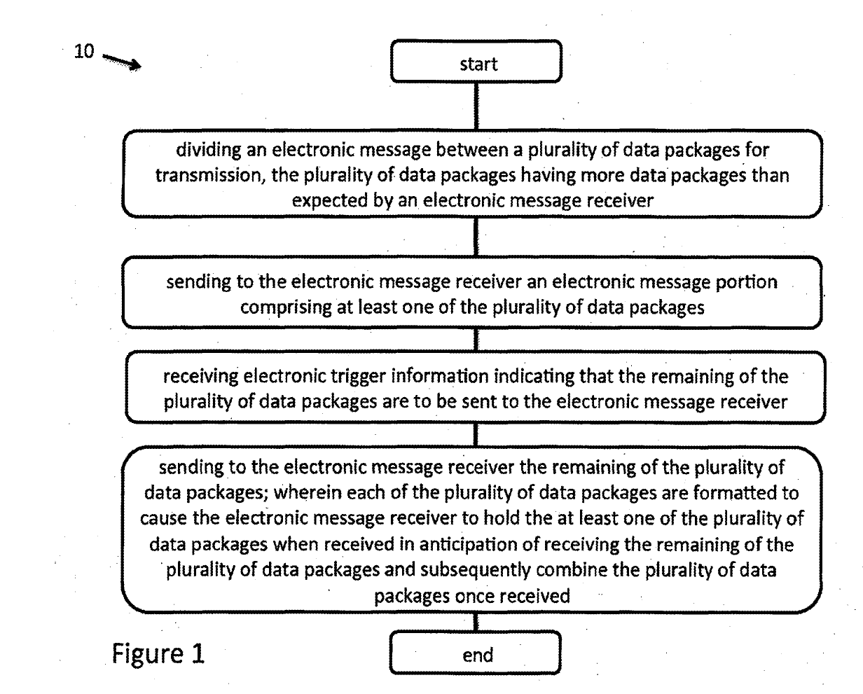

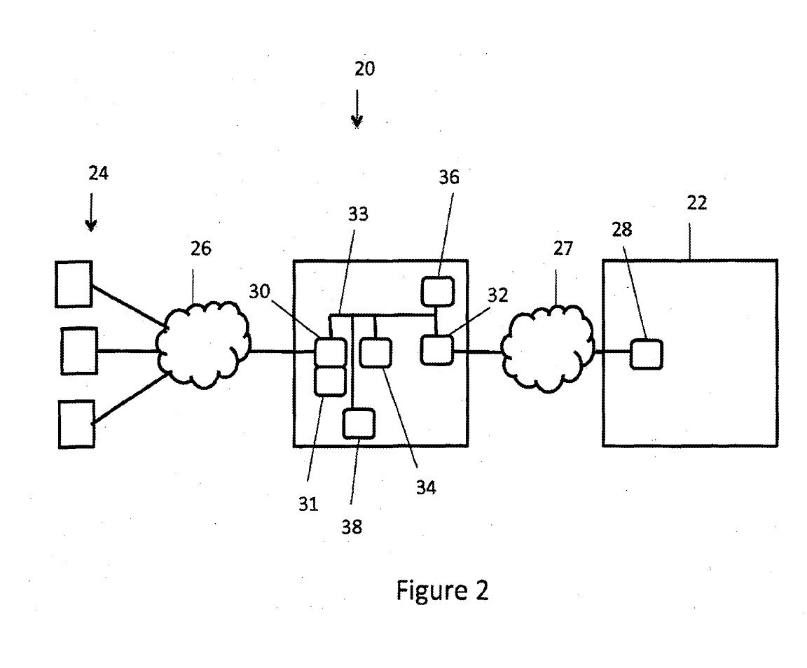

FIG. 1 shows a flow diagram of an embodiment of a method for reducing latency, the method being generally indicated by the 10. FIG. 2 shows a schematic diagram of an embodiment of a system 20 for reducing latency that can perform the steps of the method 10.

In the embodiment of FIG. 2, the system 20 is in the form of an electronic gateway between a financial instrument exchange 22, such as the Australian Stock Exchange or Korean Stock Exchange, and computers 24 configured to create orders for subsequent transmission to the financial instrument exchange 22. In some other embodiments, the system 20 is integrated with a computer 24.

The computers 24 are in communication with the system 20 over a network 26. Network 26 may be a local area network, for example. The local area network may, for example, be an Ethernet, INFINIBAND, ISDN, WiFi or any other suitable network, or T1/E1 lines. Alternatively, network 26 may be a wide area network such as the Internet. In other embodiments, the computers may each have a one-to-one connection to the system 20, via a serial, USB, FireWire, or Thunderbolt connection, or generally any suitable means. The system 20 is in communication with an electronic message receiver 28 in the form of an electronic order receiver at the financial instrument exchange 22 over, in this but not necessarily all embodiments, a local area network 27 such as Ethernet or INFINIBAND, although any suitable network or one-to-one connection may be used.

The system 20 has a plurality of units (30,31,32,34,36,38) in communication over a bus 33. One of the units is a message sender 32. An electronic message sent by the message sender is divided between a plurality of data packages. Examples of data packages include, but are not limited to, an IP packet, an IP fragment, a TCP segment, a UDP packet, and an application defined packet. The message sender 32 is arranged to send to the electronic message receiver 28 an electronic message portion comprising at least one of the plurality of data packages. The at least one of the plurality of data packages is generally an incomplete portion of the electronic message. The electronic message receiver may be expecting a message to be delivered in a quantity of data packages less than the quantity of data packages within the plurality of data packages for transmission. For example, the electronic message receiver may be expecting only one data package, and the plurality of data packages may comprise two data packages.

In the embodiment of FIG. 1, for example, the electronic message portion (the “incomplete portion”) of the electronic message may comprise stock exchange defined protocol header data which does not vary from one order to another. The incomplete portion (which has preliminary message data) may contain information that the stockbroker uses for every order. The preliminary message data may comprise other protocol header data, such as header data defined by IP and/or TCP protocols. The preliminary message data may contain proxy information in the place of some variable information yet to be defined. For example, stockbroker identification information may be replaced by a proxy identifier defined by the system 20. In one embodiment, the proxy identifier may take the form of a string of digits, although any suitable form may be used. The system may store the proxy identification in storage 38 or other storage. The data formatter may retrieve proxy information from the storage 38, for example, and include it in the electronic message portion. The stockbroker identification may be subsequently associated with the proxy information by the system (for example, by the message sender 38) for correct stockbroker identification at a later time. Other proxy information may replace other information, for example broker defined information or any other information that can be substituted by proxy information.

Variable information, such as price information, stock identification and quantity information specific to a particular order, may follow a period of time after the electronic message portion has been received by the electronic message receiver 28. For example, the electronic message portion may be sent after an order session heartbeat (as defined by, for example, the message receiver's protocol) and the variable information may follow in the form of the remaining of the plurality of data packages at any time before, for example, the subsequent heartbeat. The time period may be, for example, anywhere between 1 μs and an hour or more, although time periods outside of this range may be used.

The system 20 has an electronic trigger information receiver 30. The electronic trigger information receiver 30 is arranged to receive trigger information. In the embodiment of FIG. 2, the trigger information is remaining message information indicative of the remainder of the electronic order. The remainder of the electronic order generally comprises the variable information specific to a particular order, for example. In alternative embodiments, however, the trigger information may be distinguishable from the remaining of the plurality of data packages. For example, the trigger information may be information about a stocks performance or price, a favourable company report, or other information that may indicate a future change in stock value.

The electronic trigger information receiver 30 comprises a remaining data generator 31 arranged to generate the remaining of the plurality of data packages from the remaining message information when so received.

The message sender 32 is further arranged to send to the electronic message receiver 28 the remaining of the plurality of data packages in response to receipt of the electronic trigger information by the electronic trigger information receiver 30.

The system 20 has a data formatter 34 arranged to format the electronic message portion and the remaining of the plurality of data packages to cause the electronic message receiver 28 to hold the electronic message portion until receipt of the remaining of the plurality of data packages and subsequently combined the electronic message portion and the remaining of the plurality of data packages. For example, a TCP session may be established between the message receiver 28 and the system 20. The TCP protocol is described in the relevant publically available Internet Engineering Task Force RFC documents. TCP is a reliable stream delivery service that guarantees that all bytes received will be identical with bytes sent and in the correct order. Each of the plurality of data packages may comprise a respective IP packet having a body with a TCP segment payload. The IP packets may be created by the data formatter 34. Each of the TCP segments may in turn have a payload in the form of a respective part of an electronic message. The message may be an order, instruction or command, for example. That is, the order is divided between the TCP segments. The data sender then sends the TCP packets to the electronic message receiver 28. The TCP segments may be sequentially numbered in accordance with the TCP protocol specifications. The message receiver uses the sequence numbers of the

TCP segments to reassemble the payloads in the correct order. Once the TCP layer of the message receiver has reassembled the sequence of bytes originally transmitted, it passes them to an application program that processes and/or executes the message.

The contents of the electronic message portion may actually be expected by the electronic message receiver 28 after the contents of the remaining of the plurality of data packages. To accommodate this, the data formatter will send sequential packets with non sequential sequence numbers so that the message receiver can reorder the TCP segments in the correct logical order. The electronic message receiver 28 in accordance with the TCP protocol, arranges the received TCP segments in order of sequence number.

While the above example describes the division of the message in the transports layer (the layer in which TCP operates), it will be appreciated that the message may be divided within another layer of the Open Systems Interconnection (OSI) model, for example at the network layer using IP up to the application layer. A suitable packet based protocol may be selected in accordance with the layer selected.

In another embodiment, the data formatter is arranged to format the plurality of data packages as IP fragments. IP fragmentation is set out in the Internet Engineering Taskforce documents DARPA internet program protocol specifications RFC 791 and RFC 815, for example. In an example, the electronic message receiver 28 upon receipt of a first IP fragment will hold the first IP fragment in anticipation of a second IP fragment and combine the payload of the first and second IP fragments when received.

At least some of (or all of) the electronic message portion may be stored locally on, in this but not necessarily in all embodiments, nonvolatile data storage 38 in the form of a hard disk drive or FLASH, for example. Alternatively, at least some of (or all of) the electronic message portion may be stored locally in RAM, DRAM or some other form of volatile memory. The trigger information receiver 30 is also, in this embodiment, an electronic message portion receiver. An electronic message portion maybe received and subsequently stored on the nonvolatile or volatile data storage.

Embodiments may incur overheads including, for example, extra processing steps, resources, processing time, and an overall increase in total transmission time. Furthermore, some exchange protocols may not be compatible with embodiments without further effort by the message sender. It may, for example, be necessary to sustain a session at the transport and/or application layers. The server generally, but not necessarily, defines an application layer session. For example an application defined session may be kept alive by at least one of sending periodic ‘heartbeats’, periodically sending corrupted or erroneous packets, sending multiple order cancellations, and sending orders that will not be accepted because they are outside of the market best price range. These actions may incur further overheads, and yet surprisingly contribute to a latency advantage.

It will be appreciated that links between the system 20 and the electronic message receiver 28 that have store and forward devices, examples of which include but are not limited to routers and switches, will incur less buffer reduced latency when the message is split into smaller portions in accordance with at least some embodiments of the method.

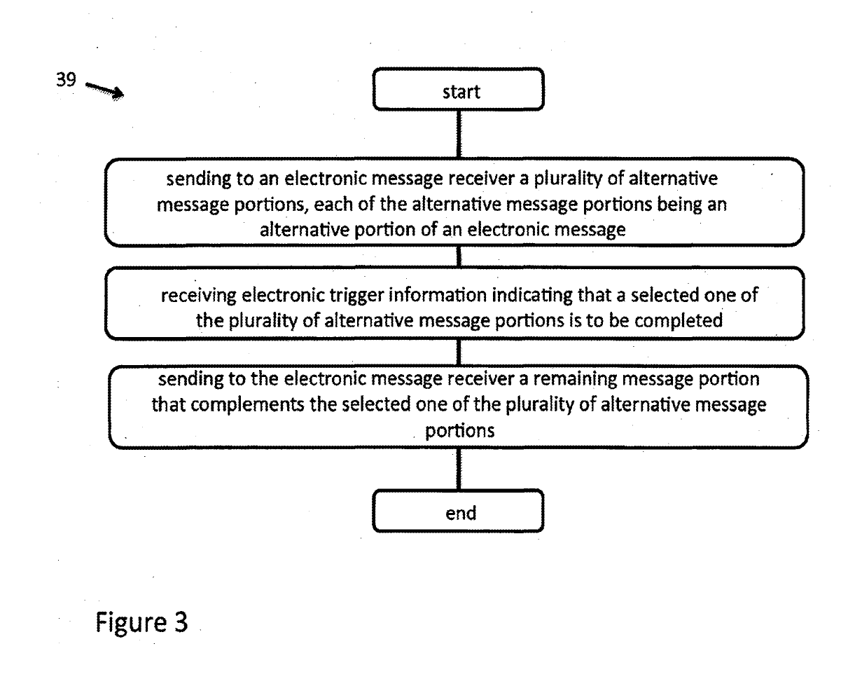

FIG. 3 shows a flow diagram of another embodiment 39 of a method of reducing latency. In a step of the method 39, a plurality of alternative message portions is sent to an electronic message receiver. Each of the alternative message portions is an alternative portion of an electronic message. In another step, electronic trigger information is received. The electronic trigger information indicates that a selected one of the plurality of alternative message portions is to be completed. In another step, a remaining message portion is sent to the electronic message receiver. The remaining message portion complements the selected one of the plurality of alternative message portions.

For example, a stockbroker may send a plurality of alternative message portions, each of the plurality of message portions being an incomplete order that differs from the other of the plurality of alternative message portions. The stockbroker may use market information, for example, to select which one of the plurality of orders to complete based of market conditions. The stockbroker is, consequently, able to take advantage of several possible eventualities in relation to stock price, traded stock volumes, client instructions etc.

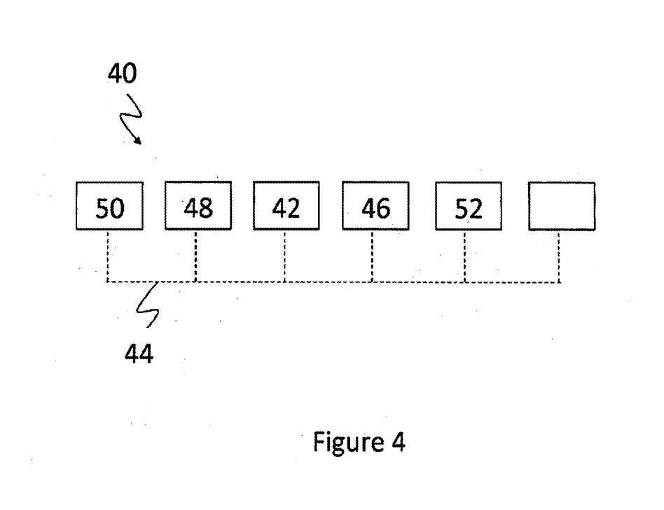

FIG. 4 shows a schematic diagram of the architecture of a processor 40 within the system 20. The processor can execute the steps of the methods of FIGS. 1 and 3, for example. The methods may be coded in a program for instructing the processor. The program is, in this embodiment stored in nonvolatile memory 48 in the form of a hard disk drive, but could be stored in FLASH, EPROM or any other form of tangible media within or external of the processor. The program generally, but not necessarily, comprises a plurality of software modules that cooperate when installed on the processor so that the steps of the method FIG. 1 (or FIG. 3) are performed. The software modules, at least in part, correspond to the steps of the method or components of the system described above. The functions or components may be compartmentalised into modules or may be fragmented across several software modules. The software modules may be formed using any suitable language, examples of which include C++ and assembly. The program may take the form of an application program interface or any other suitable software structure. The processor 40 includes a suitable micro processor 42 such as, or similar to, the INTEL XEON or AMD OPTERON micro processor connected over a bus 44 to a random access memory 46 of around 1 GB and a non-volatile memory such as a hard disk drive 48 or solid state non-volatile memory having a capacity of around 1 Gb. Alternative logic devices may be used in place of the microprocessor 42. Examples of suitable alternative logic devices include application-specific integrated circuits, FPGAs, and digital signal processing units. Some of these embodiments may be entirely hardware based for further latency reduction. The processor 40 has input/output interfaces 50 which may include one or more network interfaces, and a universal serial bus. The processor may support a human machine interface 52 e.g. mouse, keyboard, display etc.

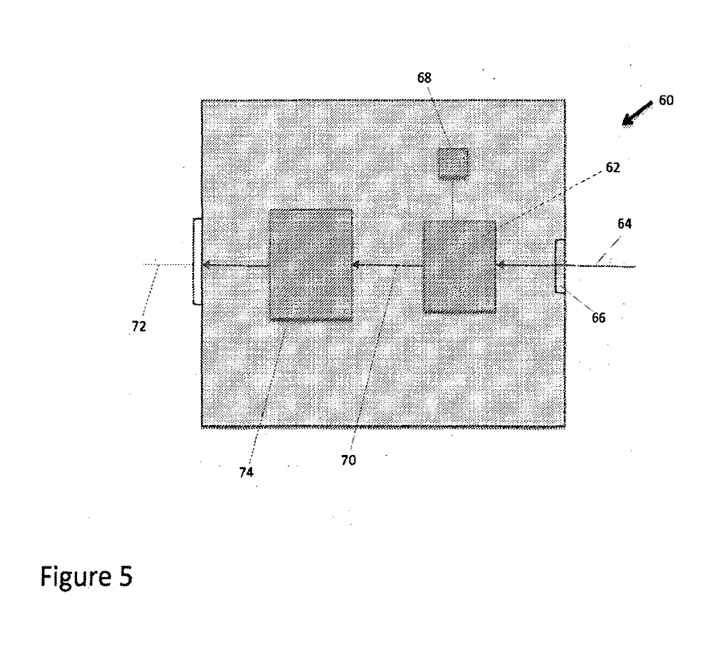

FIG. 5 shows another embodiment of system 60 for sending an electronic message. The system 60 may be arranged to perform the steps of the methods of FIG. 1 (or FIG. 3). A

CPU 62 (for example, a XEON processor) is configured to receive stimulus data 64 in the form of, for example, market data, company data, news or any other suitable stimulus data. The CPU 60 may receive the stimulus data via a network interface of the system 40. The CPU runs a programme loaded into the CPU from persistent storage 68 of system 40 that in response to receipt of the stimulus data causes the CPU to generate a trigger signal 70 that is sent to a field programmable gate array 74 (FPGA). The FPGA is arranged to execute the steps of the method of FIG. 1 or FIG. 3, for example. The FPGA then sends over a network 72 such as Ethernet or INFINIBAND the remaining of the plurality of data packages (or remaining message portion). The FPGA has sent the electronic message portion (or the plurality of alternative message portions), in this but not necessarily all embodiments, before receiving the trigger signal.

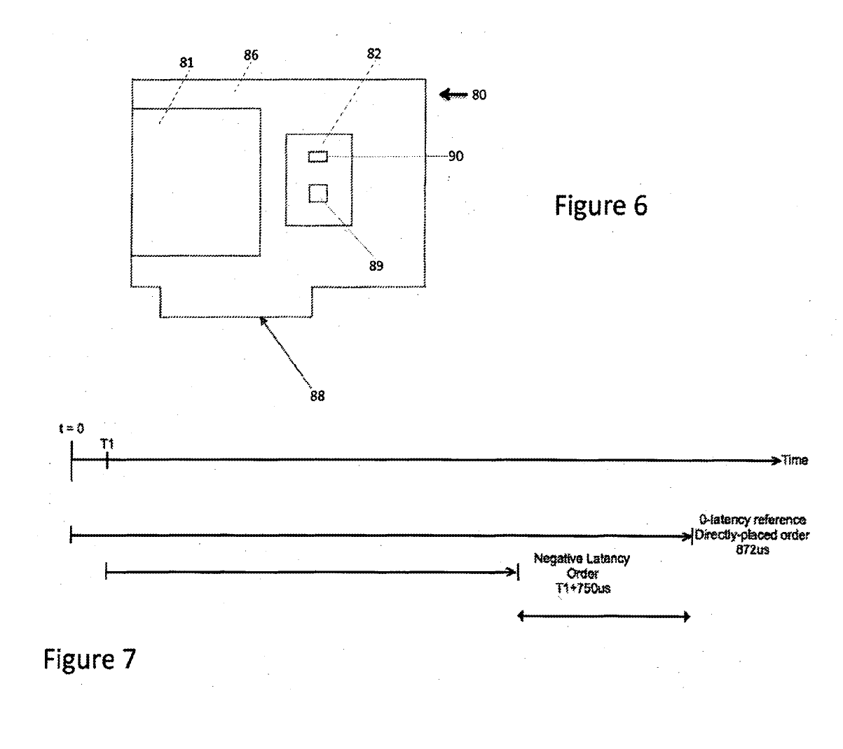

FIG. 6 shows yet another embodiment of a system 80 for sending an electronic message. The system 80 is arranged to perform the steps of the method of FIG. 1 (or FIG. 3), the system having the form of an expansion device for a computing device. The expansion device may be of any standard, such as conventional PCI, ISA, VESA, PCI Express etc. In this embodiment, the expansion device is in the form of a PCI Express expansion card arranged to be received by an expansion slot within a computing device such as a personal computer or server. Conventional PCI (PCI stands for Peripheral Component Interconnect, part of the PCI Local Bus standard and often shortened to PCI) is a computer bus for attaching hardware devices in a computing device. In another embodiment, the expansion device may take the form an integrated circuit fitted onto a motherboard, called a planar device in the PCI specification. Generally, the expansion device may take any suitable form. PCI-X and PCI Express may be used in some embodiments of the system. The PCI specification covers the physical size of the bus (including the size and spacing of the circuit board edge electrical contacts), electrical characteristics, bus timing, and protocols. The specification can be purchased from the PCI Special Interest Group (PCI-SIG).

The system 80 has a FPGA 82 and network hardware including ports 81 mounted on a card 86. The card also includes a PCI express connector 88 arranged to be received by a PCI express slot in a server, an example of which includes but is not limited to a Dell R720 server, or personal computer, for example, or generally any suitable computing device. The FPGA may receive trigger information from the computer that the system 80 is hosted by via the PCI express connector 88. Alternatively, the FPGA 82 may receive stimulus data from the computer that the system 80 is host by, in which case the FPGA determines whether trigger information should be generated in light of the stimulus data. The trigger information maybe sent by a trigger information generating module 89 within the FPGA to a message sender module 90 within the FPGA.

The FPGA 82 generally, but not necessarily, comprises a plurality of modules that cooperate so that the steps of the method FIG. 1 (or FIG. 3) are performed. In the embodiment of FIG. 5, the modules, at least in part, correspond to the steps of the method or components of the system as described above. The functions or components may be compartmentalised into modules or may be fragmented across several modules. The modules may be specified using any suitable hardware description language, examples of which include but are not limited to VHDL and VERILOG, SYSTEMVERILOG, SYSTEM-C and the LABVIEW FPGA add on module.

In some embodiments, a FPGA might send orders via a directly attached Ethernet connection. An example of an Ethernet connection includes but is not limited to 1 Gb/s Ethernet. The connection may be provided by the exchange.

In other embodiments, the CPU or FPGA may be omitted and an application-specific integrated circuit (ASIC), or a digital signal processor, may be used instead. An application-specific integrated circuit may provide especially low latency.

As described above, the system may be implemented directly in hardware. This may provide a number of the advantages over a software only solution. These advantages may include:
even lower latency, because there is no software that must first communicate with the hardware before the network packet is sent
packets may be sent in any order which may be difficult or impossible to achieve by software running on a traditional operating system which may block packet reodering
trigger information may be encoded in an extremely low latency manner, for example an edge triggered signal, an example of which is a TTL compatible digital logic signal.

In both hardware and software embodiments the trigger may require less time to transmit then a whole message or order.

### Transmission Examples

The first bytes of an order to a stock exchange may comprise the following TCP header:
The message application program interface type or protocol identifier—8 bytes—, in the form of a constant string, such as “PROTv1.0”.
The message body length—6 bytes—known a-prior.
The transaction code (identifies the type of message)—11 bytes—known a-priori (assuming a particular order type will be triggered).
Sequence number—11 bytes—can be calculated a-priori, since it is simply the next sequence number to be used
Member number (identifying the source of the order, for example a broker)—5 bytes—constant for the member sending the order.
Receiving member number—10 bytes—not used. Set as constant.
Sending member number—10 bytes—not used. Set as constant.

The above example stock exchange message receiver defined header is a total of 61 bytes. All of the above fields can be sent a-priori, that is as preliminary message data before the sending, or even creation of, the remaining of the plurality of data packages (or remaining message portion).

An example of some fields, occurring later in the order message, which cannot be known a-priori, and thus suitable for inclusion in the remaining of the plurality of data packages (or remaining message portion):
The issue code—it may not be known which particular instrument will be ordered
The order quantity—it may not be known how much of a particular order will occur.
The order price—it may not be known the price that will be offered, or asked, for the instrument.

The slowest part of the order transmission may be transmission over slow, for example 4 Mb/s, lines. A TCP message with a complete order has 382 data bytes. The Ethernet header size is 14 bytes. The IP header size is 20 bytes (without options). The TCP header size is 20 bytes (without options). Therefore a complete order, sent in one TCP message would be 382+20+20+14 bytes. This is a total of 436 bytes, taking 872 μs to completely send over the 4 Mb/s lines.

If we send the above-mentioned fields which are known a-priori using a normal TCP connection:
the electric message portion would be 14+20+20+61 bytes=115 bytes, taking 229 μs to send over a 4 Mb/s link.
the remaining of the plurality of data packages would be 14+20+20+(382−6) bytes=375 bytes, taking 750 μs to send over a 4 Mb/s link.

Therefore, an order message may be received completely by the receiver 872−750 μs=122 μs earlier than a message that is not split into an electronic message portion and the remaining of the plurality of data packages that are independently sent.

The above time calculation may be described per the standard latency description used by many exchanges. The order will be considered to be received by the exchange when the last part of the order message is received by the exchange. i.e. the order is completely received. Using the standard latency description, an embodiment may achieve a negative latency. With reference to FIG. 7, in one example:
Say that at t=0 μs, the trigger is transmitted.
At T1 the trigger is completely received. We assume that this is only a short time (relative to total transmission time) after t=0 to achieve negative latency.
Therefore, for a packet having a total transmission time of 872 μs (and assuming all other delays are constant or 0), the exchange would ordinarily receive the complete packet at t=T1+872 μs using prior art techniques.
If part of that electronic message has been sent as an electronic message portion, and the transmission time for the remaining of the plurality of data packets is reduced to 750 μs, then the exchange will receive the complete packet at t=T1+750 μs.
t1+750 μs is 122 μs before t1+872 μs—the negative latency scheme delivers the end of the order packet 122 μs−T1 earlier than if the order was sent directly to the exchange.

It will be appreciated that a similar latency advantage may be achieved using the embodiment of FIG. 3, for example.

Generally, but not necessarily, the magnitude of the negative latency value increases with decreasing link bit rate.

Variations and/or modifications may be made to the embodiments described without departing from the spirit or ambit of the invention. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

What is claimed is:

1. A method for reducing latency, the method comprising the steps of:
dividing an electronic message between a plurality of data packages for transmission, the plurality of data packages having more data packages than expected by an electronic message receiver;
sending to the electronic message receiver an electronic message portion comprising at least one of the plurality of data packages;
receiving electronic trigger information indicating that the remaining of the plurality of data packages are to be sent to the electronic message receiver; and
sending to the electronic message receiver the remaining of the plurality of data packages;
wherein each of the plurality of data packages are formatted to cause the electronic message receiver to hold the at least one of the plurality of data packages when received in anticipation of receiving the remaining of the plurality of data packages and subsequently combine the plurality of data packages once received.

2. A method defined by claim 1 comprising the step of determining the quantity of data packages that the electronic message receiver expects the message to be divided between.

3. A method defined by claim 1 wherein the electronic message portion comprises at least one of protocol header information, electronic message receiver defined header information, and information defined at the origin of the electronic message.

4. A method defined by claim 1 wherein at least some information within the remaining of the plurality of data packages is created after the step of sending the electronic message portion to the electronic message receiver.

5. A method defined by claim 1 wherein the step of receiving electronic trigger information comprises the step of receiving remaining message information from which the remaining of the plurality of data packages are generated.

6. A method defined by claim 1 wherein the electronic message comprises at least one of electronic order information indicative of an order, electronic gaming information indicative of a gaming command, and electronic wager information indicative of a wager.

7. A method defined by claim 1 wherein the electronic message receiver is an electronic order receiver, the electronic message comprises electronic order information comprising at least one of a financial instrument trade order, a domain name order, and an electronic commercial transaction order.

8. A method for reducing latency, the method comprising the steps of:
sending to an electronic message receiver a plurality of alternative message portions, each of the alternative message portions being an alternative portion of an electronic message;
receiving electronic trigger information indicating that a selected one of the plurality of alternative message portions is to be completed; and
sending to the electronic message receiver a remaining message portion that complements the selected one of the plurality of alternative message portions.

9. A method defined by claim 8 wherein the plurality of alternative message portions each comprise at least one of protocol header information, electronic message receiver defined header information, and information defined at the origin of the electronic message.

10. A method defined by claim 8 wherein at least some information within the remaining message portion is created after the step of sending the plurality of alternative message portions.

11. A method defined by claim 8 wherein the plurality of alternative message portions each comprise a respective IP fragment and the remaining message portion comprise another IP fragment.

12. A method defined by claim 8 wherein the step of receiving electronic trigger information comprises the step of receiving remaining message information from which the remaining message portion is generated.

13. A method defined by claim 8 wherein the electronic message comprises at least one of electronic order information indicative of an order, electronic gaming information indicative of a gaming command, and electronic wager information indicative of a wager.

14. A method defined by claim 8 wherein the electronic message receiver is an electronic order receiver, the electronic message comprises electronic order information comprising at least one of a financial instrument trade order, a domain name order, and an electronic commercial transaction order.

15. A system for reducing a latency, the system comprising:
a message sender arranged to send to an electronic message receiver a plurality of alternative message portions, each of the alternative message portions being an alternative portion of an electronic message;
an electronic trigger information receiver arranged to receive electronic trigger information indicating that a selected one of the plurality of alternative message portions is to be completed;
wherein the message sender is arranged to send to the electronic message receiver a remaining message portion that complements the selected one of the plurality of alternative message portions.

16. A system defined by claim 15 comprising data storage arranged to store the plurality of alternative message portions.

17. A system defined by claim 15 wherein the plurality of alternative message portions each comprise at least one of protocol header information, electronic message receiver defined header information, and information defined at the origin of the electronic message.

18. A system defined by claim 15 wherein the electronic trigger information receiver is arranged to receive the remaining message information from which the remaining message portion is generated.

19. A system defined by claim 15 wherein the electronic message comprises at least one of electronic order information indicative of an order, electronic gaming information indicative of a gaming command, and electronic wager information indicative of a wager.

20. A system defined by claim 15 wherein the electronic message receiver is an electronic order receiver, the electronic message comprises electronic order information comprising at least one of a financial instrument trade order, a domain name order, and an electronic commercial transaction order.
